(19) United States
(12) Patent Application Publication
(10) Pub. No.: US 2016/0327692 A1
(43) Pub. Date: Nov. 10, 2016

(54) 3D LENTICULAR DISPLAY METHOD AND APPARATUS

(71) Applicants: Michael Gibilisco, Longwood, FL (US); Dominic Crain, Longwood, FL (US)

(72) Inventors: Michael Gibilisco, Longwood, FL (US); Dominic Crain, Longwood, FL (US)

(21) Appl. No.: 15/216,309

(22) Filed: Jul. 21, 2016

Related U.S. Application Data
(63) Continuation-in-part of application No. 14/279,937, filed on May 16, 2014.
(60) Provisional application No. 61/825,310, filed on May 20, 2013.

(51) Int. Cl. G02B 3/00; G02B 27/22

(52) U.S. Cl. CPC G02B 3/0075; G02B 3/005; G02B 27/2214

(57) ABSTRACT

This invention relates to a method of making a three dimensional image display and to the three dimensional image display. The three dimensional image display includes an image display panel having a plurality of light emitting units to produce visual images on the face thereof. A honeycomb substrate is formed with a plurality light tubes and is laminated to a lenticular lens array. The honeycomb substrate and attached lenticular lens array are removably attached to the display panel to cover the face of the display panel with each light tube aligned over a light emitting unit on the display panel and is removably attached on the display panel by a distance to focus the lenticular lens array on the face of the display panel to allow viewing of three dimensional images displayed on the display panel.

This patent application is a continuation-in-part application of my pending U.S. patent application Ser. No. 14/279,937, filed May 16, 2014 which claims the benefit of Provisional Application No. 61/825,310, filed May 20, 2013.

### TECHNICAL FIELD

The invention relates to a design to enable a high volume production yield of consumer and commercial lenticular lens based auto-stereoscopic 3D display devices. A honeycomb substrate having light tubes therethrough is attached to a lenticular lens array to add rigidity to the lens array and is precisely aligned over the light emitting units of the display to reduce crosstalk between the light emitting units and the lens array. The lenticular lens array attached to the honeycomb substrate is removably mounted to the display panel with precise alignment.

### BACKGROUND OF THE INVENTION

A lenticular lens based auto-stereoscopic 3D device, while displaying imagery, refracts light from the pixels being displayed using lenses. As a result, different pixels are viewed depending on the location of the viewer's eyes who witness the observation. Accordingly, images entering through the right and left eye are at a different angle of view causing a binocular disparity between the images and creating a dimensional impression and/or perception of depth. The invention relates to a design to enable a high volume production yield of consumer and commercial lenticular lens based auto-stereoscopic 3D display devices. The present invention is most advantageous for use with large format display devices, such as 47 inches or greater, but can be used with smaller display devices as well. A typical display device includes a liquid crystal display (LCD), light-emitting diode (LED) display, organic light-emitting diode (OLED) display, or other pixelated display. A lenticular lens is one of the key components to the technology and has a precise alignment relationship with the pixel pitch of the display device and a set focal length that must be realized in order for the viewer to perceive the proper 3D impression. This relationship can cause the assembly of a lenticular lens based auto-stereoscopic 3D display device (especially large format) to be tedious, cumbersome and time consuming. Conventionally, the lens requirements and production workflows have made it difficult for high volume production.

### SUMMARY OF THE INVENTION

This application relates to a method of making a three dimensional image display and to the three dimensional image display. The method includes the making of a three dimensional image display including selecting an image display panel having a plurality of light emitting units to produce visual images on the face thereof and a honeycomb substrate formed with a plurality of light tubes and a lenticular lens array sized to cover the display panel. The lenticular lens array is laminated to the honeycomb substrate. The honeycomb substrate and attached lenticular lens array are then removably attached to the display panel to cover the face of the display panel aligned for each light tube to be positioned over a light emitting unit on the display panel and positioned on the display panel by a distance to focus the lenticular lens array on the face of the display panel to allow viewing of three dimensional images displayed on the display panel. The lenticular lens array attached to the honeycomb substrate increases the rigidity of the lenticular lens and substrate and is aligned with the light emitting units to isolate the lenticular lens from crosstalk between the light emitting units.

The selected honeycomb substrate has predetermined registration alignment guides and is removably attached to a registration riser which is sized to fit around the periphery of the display panel and has a predetermined shape for spacing the substrate and attached lenticular lens array relative to the face of the display panel by a distance to focus the lenticular lens on the display panel. The substrate with the attached lenticular lens array is removably attached to the registration riser using predetermined registration alignment guides and the registration riser is removably attached to the display panel to cover the face of the display panel and positions the lenticular lens for focusing on the face of the display panel to allow viewing of three dimensional images displayed on the display panel. This allows the lenticular lens to be removably mounted over the face of a display panel for easy removal and replacement without losing its alignment relative to the display panel.

### BRIEF DESCRIPTION OF THE DRAWINGS

The accompanying drawings, which are included to provide further understanding of the invention and are incorporated in and constitute a part of the specification, illustrate an embodiment of the invention and together with the description serve to explain the principles of the invention.

In the drawings:

FIG. 1 is a perspective view of a lenticular lens array;

FIG. 2 is a diagrammatic view of a lenticular lens array mounted to a substrate;

FIG. 3 is a diagrammatic view of a lenticular lens array mounted to a substrate and to a display and having diagrammatic eyes positioned for viewing the display;

FIG. 4 is an exploded view of a 3D display in accordance with the present invention;

FIG. 5 is a diagrammatic view of a 3D display having the registration riser mounting the lens to the display panel;

FIG. 6 is a partial sectional view of the riser, lens and substrate positioned on the display panel;

FIG. 7 is one embodiment of a substrate having tab cutouts for registration alignment with the riser;

FIG. 8 is an embodiment of a substrate having a pin key registration for alignment with the riser;

FIG. 9 is an embodiment of a substrate having dog eared registration for alignment with the riser;

FIG. 10 illustrates the riser registration with the tab cutout of FIG. 7;

FIG. 11 illustrates the riser registration with the pin key alignment of FIG. 8;

FIG. 12 illustrates the riser registration with the dog ear alignment of FIG. 9;

FIG. 13 is a perspective of a riser in accordance with the present invention;

FIG. 14 is a second perspective of a riser in accordance with the present invention;

FIG. 15 is plan view of a riser layout;

FIG. 16 is a sectional view taken through one side of a riser;

FIG. 17 is a sectional view taken through a narrow area of a tab on a riser.

FIG. 18 is a diagrammatic view of a section of a honeycomb substrate having light units aligned therewith;

FIG. 19 is a sectional view taken through a honeycomb substrate in accordance with the present invention; and

FIG. 20 is an exploded view of a honeycomb substrate and lens array showing a portion of the substrate enlarged.

### DETAILED DESCRIPTION OF AN EXEMPLARY EMBODIMENT

The invention will be described with reference to certain preferred embodiments. This invention may, however, be embodied in many different forms and should not be construed as limited to the embodiments set forth herein. Rather, these embodiments are provided so that this disclosure will convey preferred embodiments of the invention to those skilled in the art.

A typical display device includes a liquid crystal display (LCD), light-emitting diode (LED) display, organic light-emitting diode (OLED) display, or other pixelated display.

A lenticular lens is one of the key components to the technology and has a precise alignment relationship with the pixel pitch of the display device and a set focal length that must be realized in order for the viewer to perceive the proper 3D impression. This relationship can cause the assembly of a lenticular lens based auto-stereoscopic 3D display device (especially large format) to be tedious, cumbersome and time consuming. Conventionally, the lens requirements and production work flows have made it difficult for high volume production.

In the present application as seen in FIG. 2, a lenticule is a single optical element 11 on a lenticular sheet in a lens array 10. Pitch is the width of each lenticule while sagitta is the depth or thickness of the surface curve at a given diameter. Focal length includes the thickness and substrate thickness. Lenses per inch (LPI) is the count of lenticules per inch in a lenticular sheet.

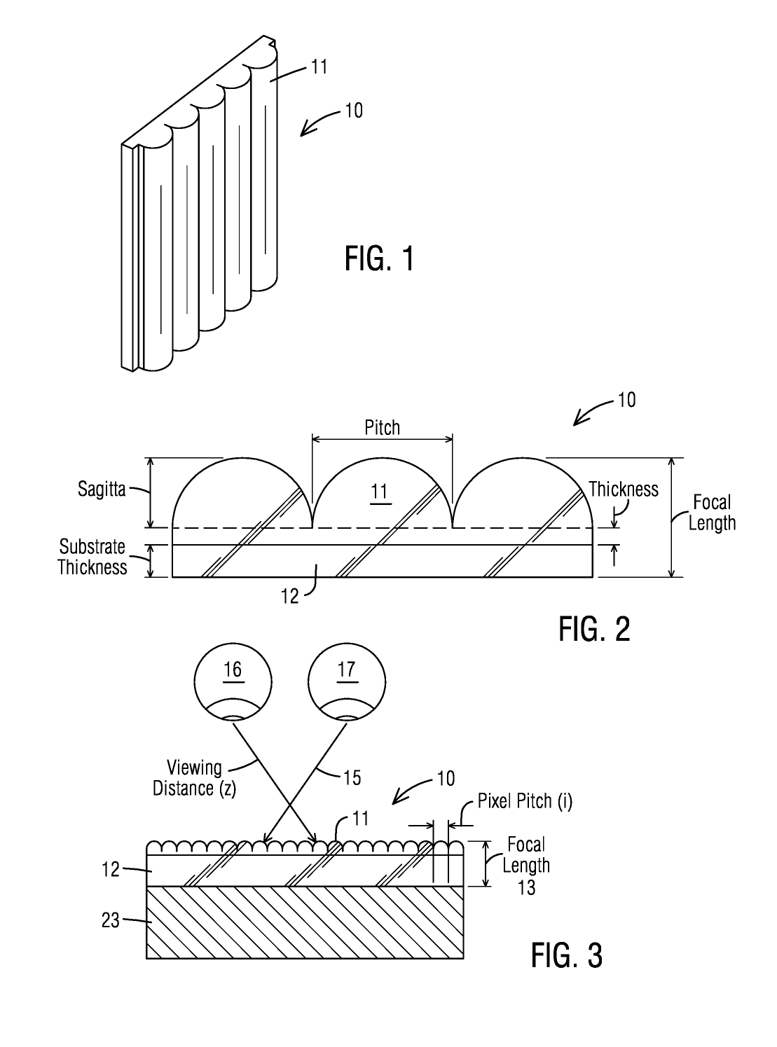

A lenticular lens 10 is a flat sheet of cast resin including an array of cylinder-shaped optical elements (lenticules) as illustrated in FIGS. 1-6. When viewed from different angles, different areas under the lens are magnified. Conventionally, the lenticular lens 10 is laminated to a thick transparent substrate 12 prior to assembly of the auto-stereoscopic 3D display device. The substrate 12 is used as a rigid support and to add the proper focal length 13 for the lens. If the lens moves from the aligned position it will cause distortions in the visual 3D impression. Therefore, it is desirable for the lens to be fixed in position. Depending on the pixel pitch 14 of the display device 18, viewing distance 15 and the approximate average pupil distance 16 of the viewer's eyes 17, the approximate optimal focal length 13 for the lens could be significantly greater than what is desired for production.

Using a 47″ 3D display as an example (FIG. 3), the relationship between the minimal lens focal length (f), the viewing distance (z), the pixel pitch (i) and an average viewer pupil distance (e) can be expressed by the following:

$$z = f ( \frac{e}{i} + 1 )$$

Where the viewing distance (z)=6 feet (1,828.8 mm), (e)=˜2.5 inches (˜63.5 mm) and (i)=˜0.02132 inches (0.5415 mm), then the focal length (f) is calculated to be ˜0.60866 inches (15.46 mm). This would indicate that from the top of the lense curve to the screen of the display device the approximate optimum focal length would be 0.60866 inches. Furthermore, if you are employing a glass substrate into your design it would increase the devices weight substantially. In this example regarding the 47″ 3D display's additional weight, we can ascertain the approximate weight by using the 2.5 kg per millimeter per square meter formula which is expressed as width in meters×height in meters×thickness in millimeters×2.5 kilograms. The substrate for the 47″ display is ˜1083.6 mm (1.0836 m) wide×˜628.8 mm (0.6288 m) height×15.46 mm thickness×2.5 kg is calculated to be ˜26.33 kg (58 lbs). During production design this additional weight must be considered.

The second most critical feature of the technology is the mathematics to properly draw an image on the display device (know as interlacing). In this process, we consider each row of the output image as a row of sub-pixels R, G, or B (determined by the display manufacture). The number of sub-pixels being covered by a single line of the lenticular lens at the slant angle chosen, determines the number of views available in the lens viewing cone. Using information on the width of a lens line, the angle of the lens slant, and the offset of the top-left corner first lens line, we can compute for each sub-pixel in a row what view the sub-pixel corresponds to. Based on the view determined from the above calculation, we get the appropriate R, G, or B (as appropriate for the sub-pixel being sampled) from the source view image. This is key to produce the proper dimensional impression. These calculations are processed in realtime with our 3D motherboard.

In accordance with an embodiment of the invention, unique components are assembled to create a 3D auto-stereoscopic production unit which can advantageously reduce the manufacturing time to precisely position a lenticular lens 10 to a display device 18, reduce alignment issues, reduce weight issues and bulkiness that can occur by using a heavy substrate to support the lens, enhance the speed of mounting the lenticular lens 10 to the display device 18 while maintaining accuracy and allowing for high yield production runs, mount the lens in a locked long-term position that will not change over time due to poor bonding methods, enable the ability to remove the mounted lens from the display device without damaging the display device. This latter aspect includes the ability to replace a lens onsite or offsite (the auto-stereoscopic 3D display device).

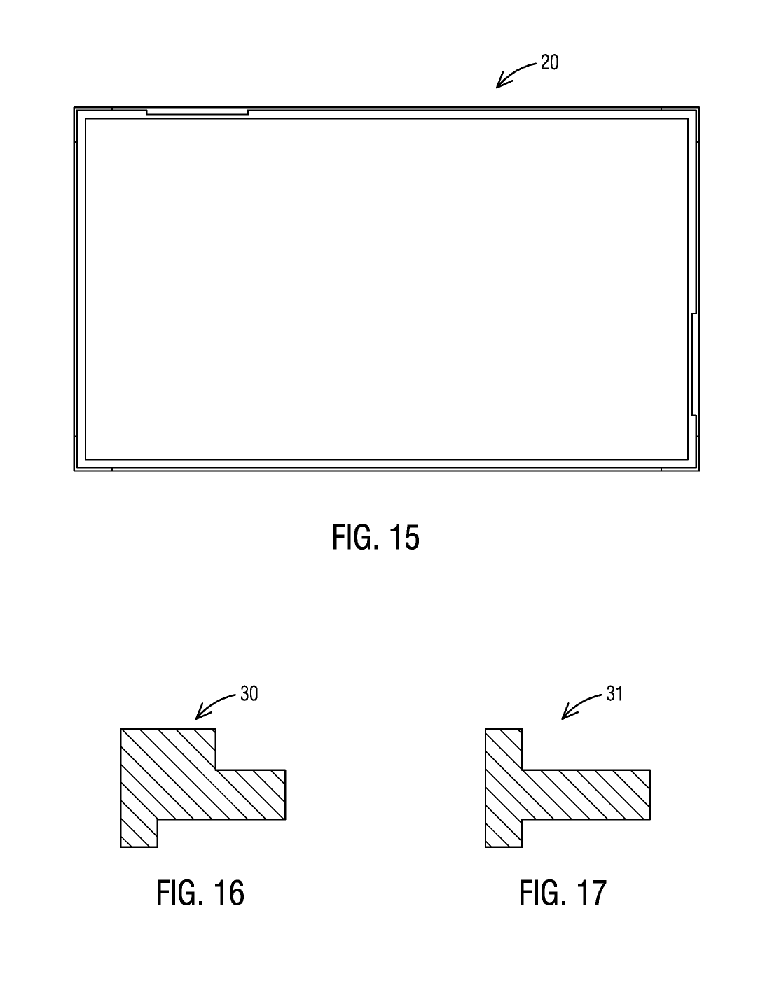

Reference is now made to the drawings, FIGS. 1 through 20 that illustrate preferred embodiments of the invention.

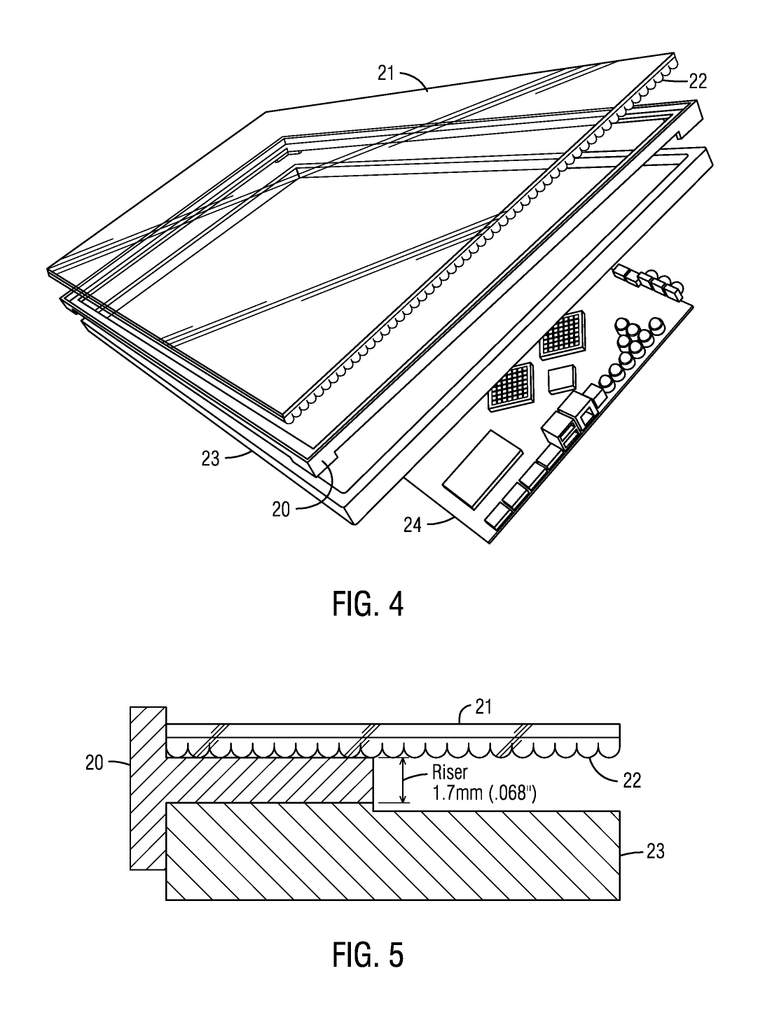

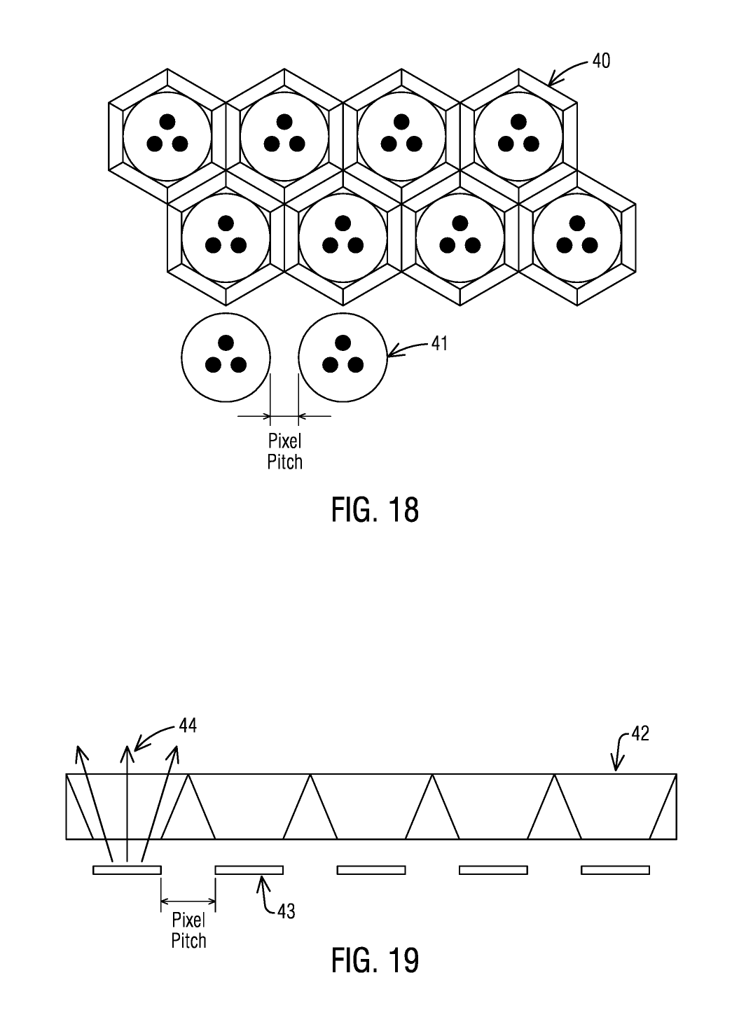

FIG. 4 is an exploded view of the 3D display which includes the invention which is the registration riser 20, the register substrate 21, lenticular lens 22, display panel 23 and 3D motherboard 24. The lens 22 is laminated to the substrate 21 which uses a registration system to lock it into position with the riser 20. Once aligned with the riser 20, the substrate 21 and lens 22 are bonded to the riser 20 with a UV curing epoxy. The riser 20 is then attached to the panel 23 of the display device. This riser 20 mount is detachable and will not damage the display device. The riser is snapped onto the display and held thereto with small screws to keep it from moving. The overall production design is precise and extremely quick to assemble. The 3D motherboard 24 is mounted to the display panel 23. The lenticular lens 21 of the present invention, as seen in FIG. 5, is mounted the reverse of the normal mounting of the normal prior art lenticular lens 10 illustrated in FIG. 3 so that the substrate 21 supporting the lenticular lens 21 is positioned on the opposite side of the lens 21 from the riser 20. The substrate used in this application is different than a traditional substrate as is explained in connection with FIGS. 18, 19 20 hereinafter. It is composed of tiny hexagonal/octagonal tubes fused together to form a honeycomb structure. The design of this honeycomb substrate has two primary functions: 1) to focus the light rays from the light emitting technology (LED, OLED, etc.) to the proper position of the lenticular lens and 2) reduce the substrates weight and thickness while maintaining structural integrity.

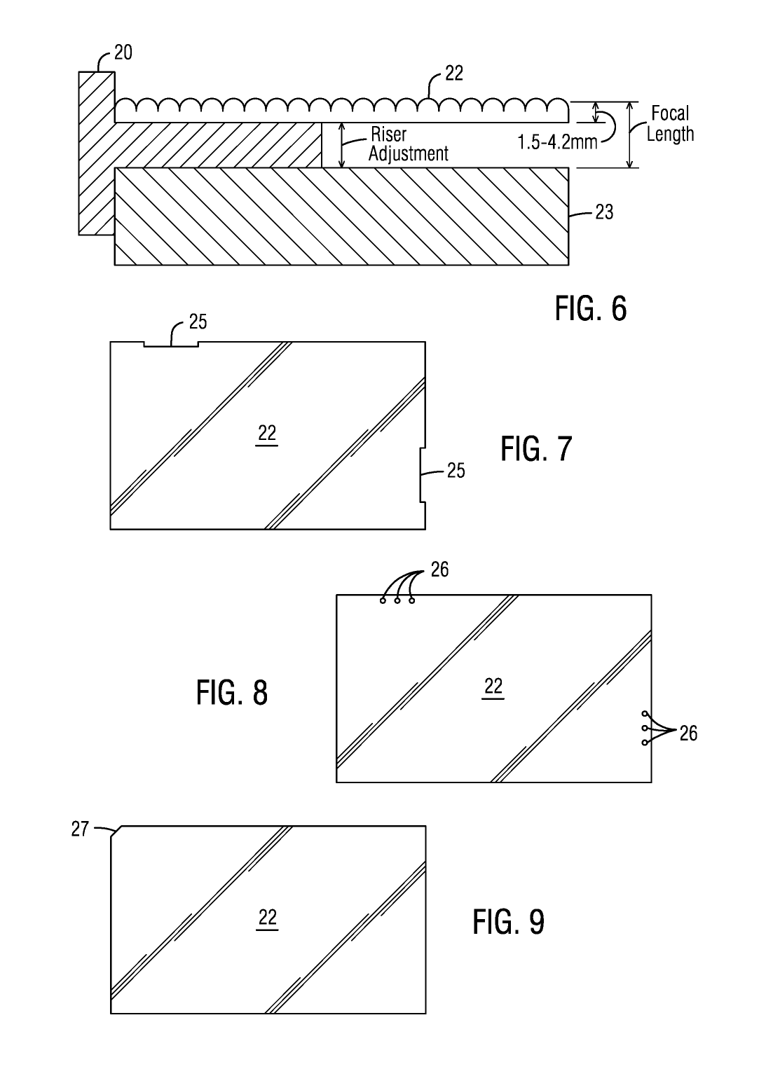

FIGS. 5 and 6 illustrate the use of the riser 20 height to ensure proper focal length while reducing weight and thickness of the lens array. This is important while calculating additional load bearing weight to the overall device design and ease of assembly during production. The substrate and lens are preferably between approximately 1 to 8 mm in thickness. For the example of the 47″ display, the preferred thickness is 1.5-4.2 mm. Typically this system would meet the correct focal length for the lens and weigh approximately 6 lbs including the riser 20.

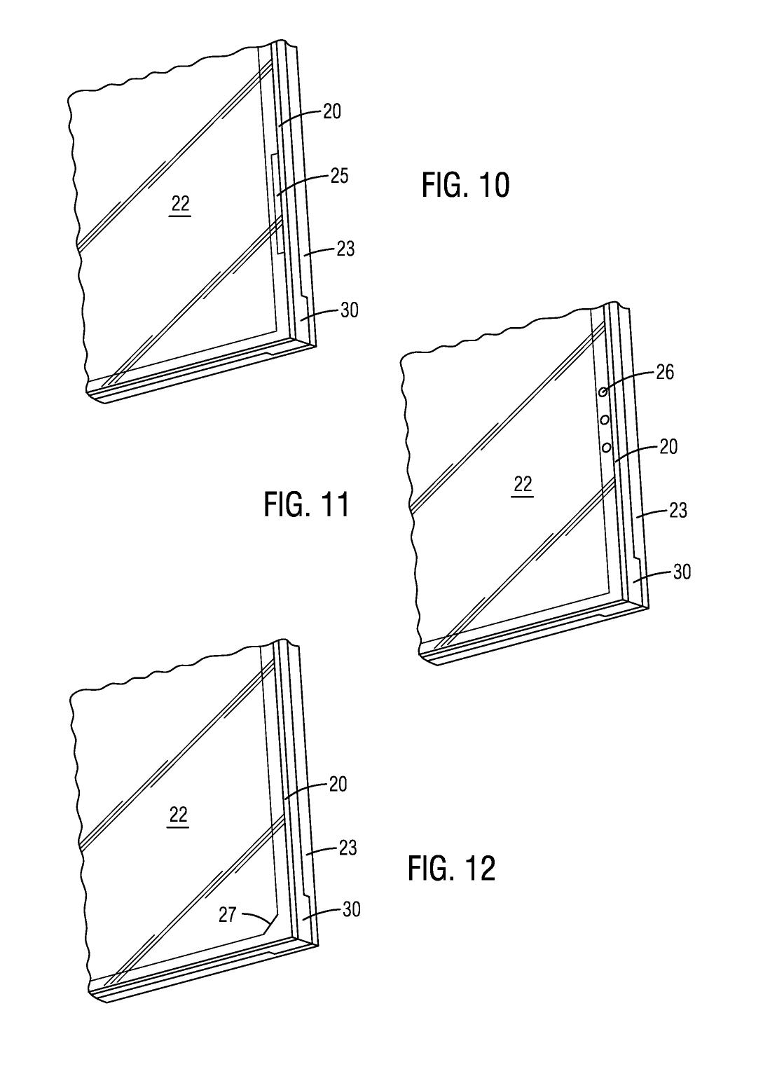

FIGS. 7, 8 and 9 illustrate a registration design. The lens substrate array employs a unique system designed to make it a keyed/registered component. Embodiments include three designs with different registration features: the tab method (FIG. 7) having tabs 25, the pin method (FIG. 8) having pins and the dog eared method (FIG. 9) having dog eared corners 27. In addition, the registration position is applied to the lens lamination process ensuring the proper position of the lenticular lens 22. Once the lens substrate is aligned, it is permanently bonded to the riser using a UV curing epoxy.

FIGS. 10, 11 and 12 illustrate the application of the lens registration feature. The registration locks the lens 22 into position according to the optimum relationship parameters between the display device 23 and the lens 22. This system precisely positions the lens 22 to the display device 23 and makes sure that it is in the proper facing position.

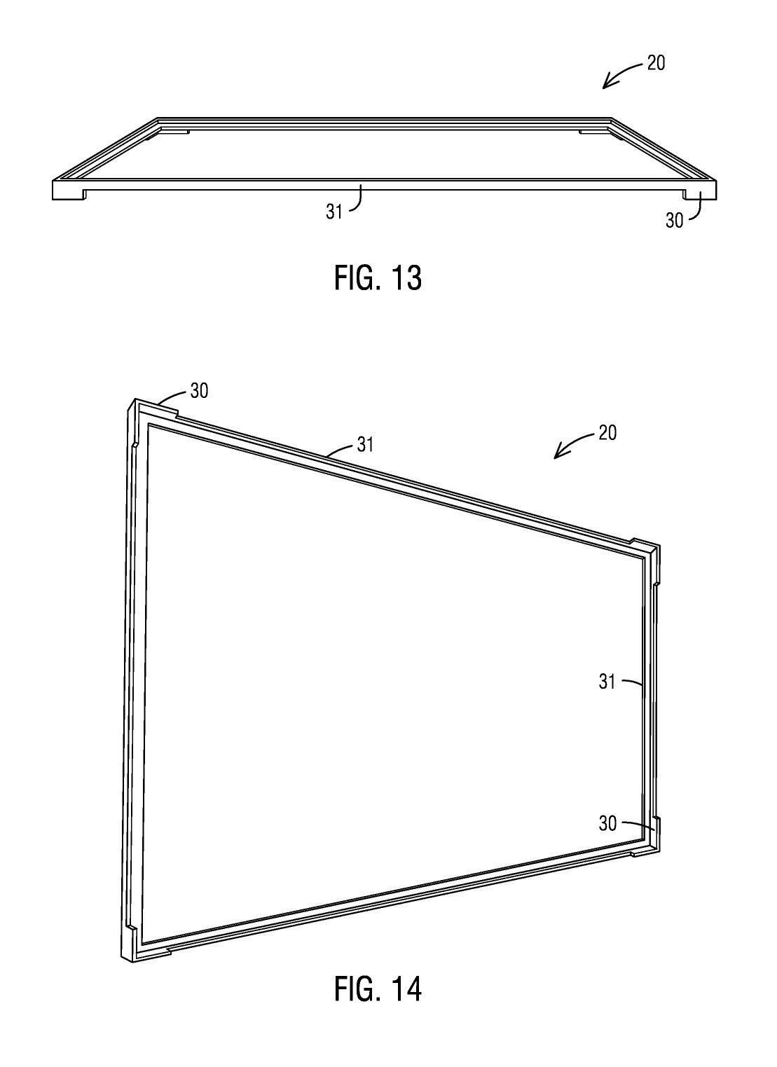

FIGS. 13, 14 and 15 illustrate a riser 20 design. The riser 20 is unique to each lenticular lens array 22 and display device 23. It is preferably constructed from plastic, metal, or the like. It has four corner mount angles 30, shown in cross-section in FIG. 16, that snap down on the display device 23 and a lip 31, shown in cross-section in FIG. 17, that runs along the entire perimeter of the display device ensuring a rigid and secure mount.

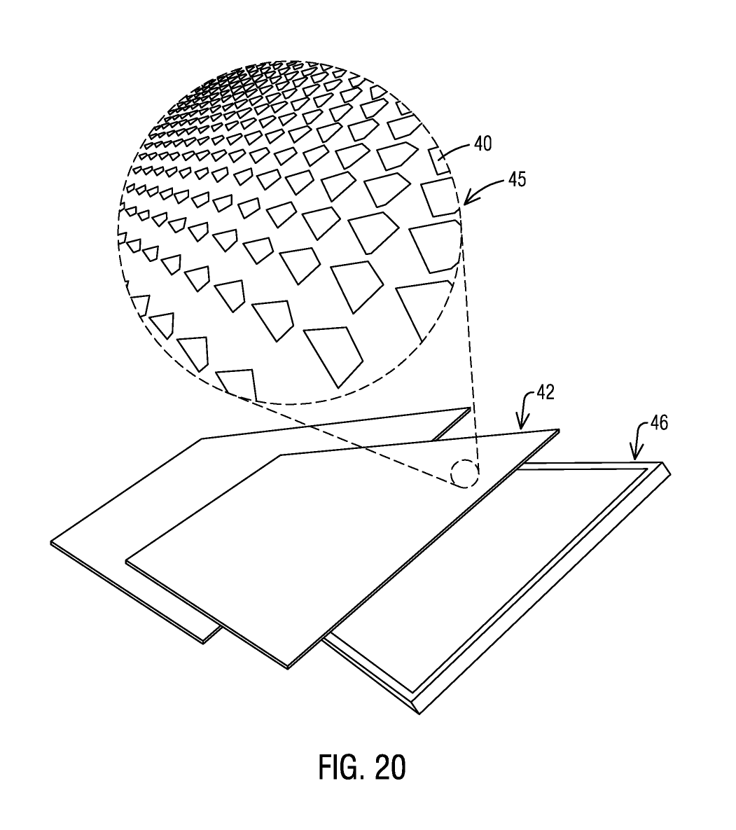

The honeycomb substrate 42 used in the present invention is different from a traditional substrate. It is composed of tiny angled hexagonal/octagonal tubes fused together to form a honeycomb structure 40. The design of the substrate has two primary functions: 1) to focus the light rays from the light emitting technology (LED, OLED, etc.) to the proper position of the lenticular lens and 2) to reduce the substrate's weight and thickness while maintaining structural integrity. FIG. 18 illustrates the honeycomb substrate design 40. The substrate is unique in its dual purpose nature. The honeycomb increases the rigidness and reduces the tendency to flex compared to chemically hardened glass. The tiny hexagonal/octagonal tubes act as light field conduits. These conduits act similar to a fiber optic fiber and direct the light rays to the proper location of that specific portion of the lens. They are designed to sit precisely over the light emitting units 41, such as LEDs, OLEDs, etc. This dramatically reduces crosstalk, isolates the lens so it will not be affected by the pixel pitch and creates a more effective lens alignment, because of each tubes position in relation to the light emitters. In addition, the substrate will produce brighter imagery because it reduces the amount of light bleed. FIG. 19 illustrates the substrate 42 above the light emitting technology 43 and how it assists in directing light rays 44. FIG. 20 illustrates a zoomed-in sectional piece 45 of the substrate 42.

Some advantages of the invention are now described. Use of the riser allows one to create a high yield manufacturing pipeline to produce 3D lenticular lens display devices. It also reduces the overall weight of a large format 3D lenticular lens display device relative to conventional designs. While minimizing weight, however, one can still maintain the proper focal length and use a thin honeycomb substrate to support the lens. The riser allows one to precisely register a lenticular lens array to the display device during manufacturing using a keyed registration system and locks the lenticular lens into position to reduce lens alignment errors and ensure long-term position alignment. The riser 20 allows one to precisely mount and secure a lenticular lens 22 to a display device 23 without bonding the lens 22 directly to the display device 23. The riser 20 is removably mountable to the lenticular lens 22, so if the lens 22 is damaged and/or not at the required specifications, it can be replaced without damaging the display device 23.

The invention has been described above with reference to preferred embodiments. Unless otherwise defined, all technical terms used herein are intended to have the same meaning as commonly understood in the art to which this invention pertains and at the time of its filing. Although various methods and materials similar or equivalent to those described herein can be used in the practice or testing of the present invention, suitable methods and materials are described. However, the skilled should understand that the methods and materials used and described are examples and may not be the only ones suitable for use in the invention. Accordingly, this invention may be embodied in many different forms and should not be construed as limited to the embodiments set forth herein. Rather, these embodiments are provided so that this disclosure will convey the preferred embodiments of the invention to those skilled in the art. The invention has been described in some detail, but it will be apparent that various modifications and changes can be made within the spirit and scope of the invention as described in the foregoing specification.

We claim:

1. A method of making a three dimensional image display having the steps of:
selecting an image display panel having a plurality of light emitting units to produce visual images on the face thereof;
selecting a honeycomb substrate formed with a plurality of light tubes;
selecting a lenticular lens array sized to cover said display panel;
laminating said lenticular lens array to said honeycomb substrate;
removably attaching said honeycomb substrate and attached lenticular lens array to said display panel to cover the face of said display panel with each light tube positioned over a light emitting unit on said display panel and positioned on said display panel by a distance to focus said lenticular lens array on the face of said display panel to allow viewing of three dimensional images displayed on said display panel;
whereby said lenticular lens array attached to said honeycomb substrate increases the rigidity of said lenticular lens and is aligned with said light emitting units to isolate the lenticular lens from crosstalk between said light emitting units.

2. The method of making a three dimensional image display in accordance with claim 1 in which said honeycomb substrate has a plurality of octagonal light tubes therethrough.

3. The method of making a three dimensional image display in accordance with claim 1 in which said honeycomb substrate has a plurality of hexagonal light tubes therethrough.

4. The method of making a three dimensional image display in accordance with claim 1 in which each said honeycomb substrate light tube is an angled tube.

5. The method of making a three dimensional image display in accordance with claim 1 including the step of attaching said display panel to a motherboard for generating said image for three dimension viewing through said lenticular lens.

6. The method of making a three dimensional image display in accordance with claim 1 in which each of said plurality of light emitting units is an LED.

7. The method of making a three dimensional image display in accordance with claim 1 in which each of said plurality of light emitting units is an OLED.

8. A three dimensional image display comprising:
an image display panel having a plurality of light emitting units for displaying visual images;
a registration riser sized to fit around the periphery of said display panel and removably attached to said display panel, said registration riser having a plurality of right angle corners for aligning said registration riser with said display panel and said registration riser having a spacer portion for spacing said registration riser relative to said display panel;
a honeycomb substrate formed with a plurality of light tubes and having a plurality of alignment guides;
a lenticular lens array sized to cover said display panel, said lenticular lens array being laminated to said honeycomb substrate; and
said honeycomb substrate having said lenticular lens array laminated thereto being attached to said registration riser aligned by said substrate alignment guides to position the attached honeycomb substrate and lenticular lens array relative to the face of said display panel and positioned by said registration riser spacer portion from said display panel by a distance to focus said lenticular lens on said display panel for viewing three dimensional images and to align each said honeycomb substrate light tube with one said light emitting unit;
whereby said lenticular lens array for viewing a three dimensional image on a display panel can be easily attached and detached from a display panel while maintaining its alignment relative to said display panel.

9. The three dimensional image display in accordance with claim 8 in which said honeycomb substrate plurality of alignment guides includes a plurality of alignment guide notches matching a plurality of registration riser tabs.

10. The three dimensional image display in accordance with claim 8 in which said honeycomb substrate plurality of alignment guides includes a plurality of alignment guide registration pin holes matching a plurality of registration riser pins.

11. The three dimensional image display in accordance with claim 8 in which said honeycomb substrate plurality of alignment guides includes a plurality of dog eared corners matching registration riser corners.

12. A three dimensional image display comprising:
an image display panel having a plurality of light emitting units for displaying visual images;
a honeycomb substrate having a plurality of light tubes;
a lenticular lens array sized to cover said display panel laminated to said honeycomb substrate;
said honeycomb substrate having said lenticular lens array laminated thereto being attached to position the attached honeycomb substrate and lenticular lens array relative to the face of said display panel and positioned to align each said honeycomb substrate light tube with one said light emitting unit and spaced from said display panel by a distance to focus said lenticular lens on said display panel for viewing three dimensional images;
whereby said honeycomb substrate increases the rigidity of said attached lenticular lens array and isolates the lenticular lens from crosstalk between said light emitting units.

13. The three dimensional image display in accordance with claim 12 in which said honeycomb substrate has a plurality of angled octagonal light tubes therethrough.

14. The three dimensional image display in accordance with claim 12 in which said honeycomb substrate has a plurality of angled hexagonal light tubes therethrough.

15. The three dimensional image display in accordance with claim 12 in which each of said plurality of light emitting units is an LED.

16. The three dimensional image display in accordance with claim 12 in which each of said plurality of light emitting units is an OLED.
